(19) United States
(12) Patent Application Publication
(10) Pub. No.: US 2021/0010449 A1
(43) Pub. Date: Jan. 14, 2021

(54) ENGINE PHASE DETERMINATION AND CONTROL

(71) Applicant: Walbro LLC, Tucson, AZ (US)

(72) Inventors: Takashi Abei, Izumi-ku, Sendai-city (JP); Shunya Nakamura, Iwanuma-city (JP); Dairoku Suzuki, Watari-Gun (JP); Jun Takano, Shibata-Gun (JP); Yuki Tanaka, Natori-City (JP); Kazunori Tsubakino, Iwanuma-City (JP); Makoto Waku, Tomiya-City (JP)

(21) Appl. No.: 16/977,236

(22) PCT Filed: Mar. 14, 2019
(86) PCT No.: PCT/US2019/022258

§ 371 Date: Sep. 1, 2020

Related U.S. Application Data
(60) Provisional application No. 62/643,474, filed on Mar. 15, 2018.

(51) Int. Cl. F02P 5/06; F02B 75/02; F02B 75/18; F02D 41/00; F02D 41/30; F02P 1/08

(52) U.S. Cl. CPC F02P 5/06; F02B 75/02; F02B 75/18; F02D 41/009; F02D 2200/021; F02P 1/08; F02D 41/008; F02B 2075/027; F02D 2200/101; F02D 41/30

(57) ABSTRACT

In at least some implementations, a method of controlling spark events in an engine includes determining for at least two engine revolutions in a four-stroke engine at least one characteristic of the primary coil voltage for a spark event, determining, based upon the characteristic of the primary coil voltage, which of the spark events is associated with a compression phase and which of the spark events is associated with an exhaust phase of engine operation, and providing spark events in subsequent engine revolutions that are associated with the compression phase of engine operation but not in revolutions associated with the exhaust phase of engine operation. In at least some implementations, the characteristic is the duration of the spark event as determined by changes in the primary coil voltage, and the characteristic may be that the duration that the primary coil voltage is above a threshold voltage.

### REFERENCE TO RELATED APPLICATIONS

This application claims the benefit of U.S. Provisional Application Ser. No. 62/643,474 filed on Mar. 15, 2018, the entire contents of which is incorporated herein by reference in its entirety.

### TECHNICAL FIELD

The present disclosure relates generally to a method of determining the phase of and controlling an engine within the cycles of an internal combustion engine.

### BACKGROUND

Internal combustion engines may include an ignition circuit that drives a spark plug to produce a spark that ignites a fuel mixture in the engine. Four-stroke engines include combustion, exhaust, intake and compression strokes and complete an engine cycle within two revolutions of the engine. An ignition spark is only needed for the combustion phase, so determining the various engine phases during operation of the engine can, among other things, facilitate efficient provision of the spark during the combustion phase, and enable adjustment of the fuel mixture delivered to the engine. For many engines, the ignition circuit includes or is associated with magnets rotated by the engine (e.g. on a flywheel) to induce electricity in one or more coils that is used to drive the spark plug and sometimes other electrical components.

### SUMMARY

In at least some implementations, a method of controlling spark events in a combustion engine includes determining for at least two engine revolutions in a four-stroke engine at least one characteristic of the primary coil voltage for a spark event, determining, based upon the characteristic of the primary coil voltage, which of the spark events is associated with a compression phase of engine operation and which of the spark events is associated with an exhaust phase of engine operation, and providing spark events in subsequent engine revolutions that are associated with the compression phase of engine operation but not in revolutions associated with the exhaust phase of engine operation. In at least some implementations, the characteristic is the duration of the spark event as determined by changes in the primary coil voltage, and the characteristic may be that the duration that the primary coil voltage is above a threshold voltage.

In at least some implementations, a system for managing ignition of a four-stroke internal combustion engine includes a primary coil and a secondary coil used to create a spark event, a switch the state of which is changed to cause a spark event to occur, and a processing device coupled to the switch and operable to change the state of the switch. The processing device is responsive to a voltage of the primary coil, or a signal representative of the primary coil voltage, to determine, based upon a characteristic of the primary coil voltage, at least one spark event that is associated with a compression phase of engine operation and at least one spark event that is associated with an exhaust phase of engine operation and to provide spark events in subsequent engine revolutions that are associated with the compression phase of engine operation but not in revolutions associated with the exhaust phase of engine operation.

In at least some implementations, a method of providing fuel to a multi-cylinder engine from a single control valve includes determining the intake phase of engine operation for each cylinder, determining one or more of engine operating conditions including temperature, engine speed and number of revolutions since engine starting, determining a fuel control valve instruction as a function of at least one of the engine operating conditions, and opening a fuel control valve in accordance with the fuel control valve instruction and at a time corresponding with the intake phase of at least one cylinder.

In at least some implementations, the fuel control valve instruction is determined as a function of engine temperature and number of revolutions since engine starting. In at least some implementations, the fuel control valve instruction is determined as a function of engine temperature and engine speed. In at least some implementations, the fuel control valve instruction includes one or more instructions as to the frequency that the fuel control valve is to be opened and the duration that the fuel control valve is opened during an actuation. In at least some implementations, the fuel control valve is opened one or both of less frequently and for a shorter duration of time when the engine is warmer than when the engine is colder. In at least some implementations, the fuel control valve instruction results in the fuel control valve being opened during the intake phase of each cylinder. And the fuel control valve instruction may result in the fuel control valve being opened during the intake phase of one cylinder but not the other. In at least some implementations, the fuel control valve instruction results in the fuel control valve being opened one or both of more frequently and for a longer duration during the intake phase of one cylinder compared to the fuel control valve actuation during the intake phase of the other cylinder.

In at least some implementations, a method of determining at least certain phases of engine operation for an engine with which a magneto ignition system is used, wherein the magneto ignition system includes a magnet and a coil in which energy is induced by the magnet, includes comparing, during consecutive engine revolutions, at least one characteristic of the voltage induced in the coil and determining which revolution includes an exhaust phase of engine operation and which revolution includes a compression phase of engine operation based upon a difference in the at least one characteristic.

In at least some implementations, the characteristic is the time for at least a portion of a waveform of the voltage induced in the coil. The waveform may include a first portion of a first polarity, a second portion of a second polarity and a third portion of the first polarity and the portion of the waveform from which the time is taken includes all of the second portion. The waveform may include a first portion of a first polarity, a second portion of a second polarity and a third portion of the first polarity and the portion of the waveform from which the time is taken includes the first portion and the second portion.

In at least some implementations, the characteristic is one of the time or rate of change from a first voltage to a second voltage. In at least some implementations, the magneto includes two magnets located on a rotatable flywheel so that two waveforms are induced in the coil each revolution of the flywheel, and wherein the characteristic is the time for at least a portion of a revolution compared to the time for the entire revolutions, and such comparison is made for consecutive revolutions. The magnets may be spaced apart a known distance and the time from the end of the waveform from a first magnet until the end of the waveform from a second magnet is compared to the time for a complete engine revolution. The magnets may be spaced apart a known distance and the time from the end of the waveform from a first magnet until the end of the waveform from a second magnet is compared to the time from the end of the waveform from the second magnet to the end of the waveform from the first magnet in the next engine revolution. And the comparisons or ratios of times may both be used in determining engine phases of operation.

### BRIEF DESCRIPTION OF THE DRAWINGS

The following detailed description of certain embodiments and best mode will be set forth with reference to the accompanying drawings, in which:

FIG. 1 shows an ignition system generally having a stator assembly mounted adjacent a rotating flywheel;

FIG. 2 is a is a schematic diagram of an embodiment of a control circuit that can be used with the ignition system of FIG. 1, where the control circuit is illustrated as Transistor Controlled Ignition (TCI) system;

FIG. 3 is a graph showing waveforms for primary coil voltage;

FIG. 4 is a graph showing primary coil voltage during a compression phase of a four-stroke engine's operation;

FIG. 5 is a graph showing primary coil voltage during an exhaust phase of a four-stroke engine's operation;

FIG. 6 is a graph showing a primary coil voltage waveform, an ignition spark waveform, a ignition switch control waveform for multiple engine revolutions;

FIG. 7 is a simplified graph showing revolutions, spark events, and primary coil voltage durations above a threshold voltage, and the various engine phases associated with the waveforms;

FIG. 8 is a simplified chart showing engine phases, associated spark events and primary coil voltage durations about the threshold voltage for the spark events;

FIG. 9 is a simplified graph showing revolutions, spark events, and primary coil voltage associated with total spark duration, and the various engine phases associated with the waveforms

FIG. 10 is a simplified chart showing engine phases, associated spark events and primary coil voltage associated with spark duration for the spark events;

FIG. 11 is a flowchart of a method of determining engine phase to enable determination of when a spark is needed;

FIG. 12 is a flowchart of a method of determining engine phase to enable determination of when a spark is needed;

FIG. 13 is a perspective view showing a portion of an engine with a first fuel supply device and a second fuel supply device coupled to the engine;

FIG. 14 is a sectional view of a portion of the first fuel supply device of FIG. 13 showing some internal components thereof;

FIG. 15 is a perspective view of the second fuel supply device;

FIG. 16 is a sectional view of the second fuel supply device;

FIG. 17 is a flow chart of one example of a method used to control action of a valve of the second fuel supply device, or another fuel supply valve or injector;

FIG. 18 is a graph showing, from the top down, engine revolutions, ignition system pulses indicative of ignition events, fuel control valve actuation timing, and engine cycle phases for two cylinders of the engine;

FIG. 19 is a graph showing, from the top down, an engine intake manifold pressure, fuel control valve actuation timing, ignition system pulses indicative of ignition events, and engine cycle phases for two cylinders of the engine, wherein the fuel control valve is actuated every engine revolution and fuel is alternately provided during the intake phase of both cylinders;

FIG. 20 is a graph showing, from the top down, an engine intake manifold pressure, fuel control valve actuation timing, ignition system pulses indicative of ignition events, and engine cycle phases for two cylinders of the engine, wherein the fuel control valve is actuated every sixth engine revolution and fuel is provided during the intake phase of a first cylinder;

FIG. 21 is a graph showing, from the top down, an engine intake manifold pressure, fuel control valve actuation timing, ignition system pulses indicative of ignition events, and engine cycle phases for two cylinders of the engine, wherein the fuel control valve is actuated every sixth engine revolution and fuel is provided during the intake phase of a second cylinder;

FIG. 22 is a schematic diagram of a Transistor Controlled Ignition (TCI) system;

FIG. 23 is a graph showing two voltage waveforms;

FIG. 24 is a graph showing a voltage waveform;

FIG. 25 is a graph showing a voltage waveform;

FIG. 26 is a diagrammatic view of a flywheel with magnets mounted thereon;

FIG. 27 is a graph of a voltage waveform for two revolutions of a flywheel as shown in FIG. 26; and

FIG. 28 is a graph of time increments related to engine revolutions during different phases of engine operation.

### DETAILED DESCRIPTION

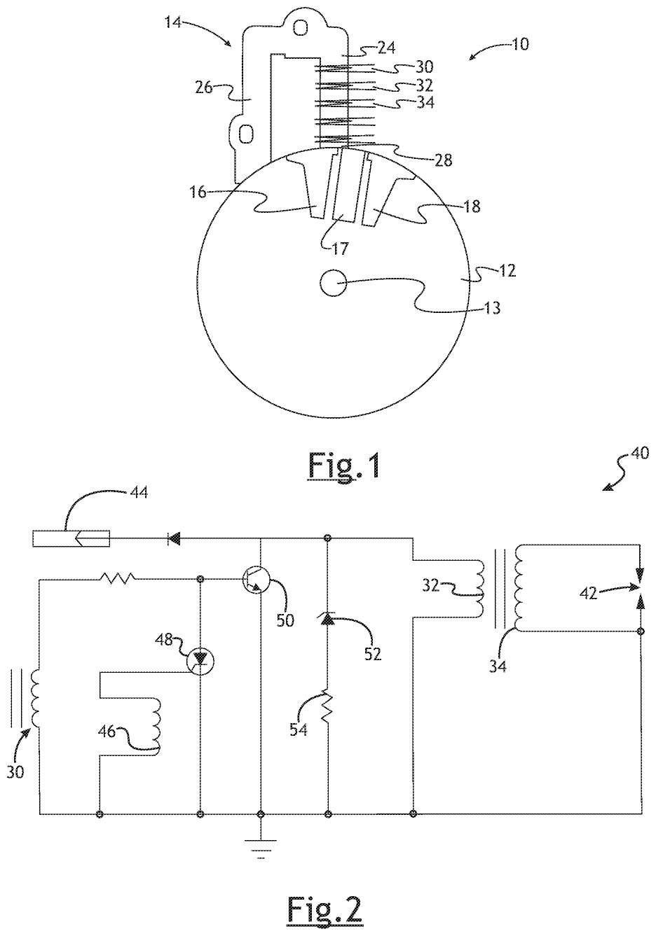

Referring in more detail to the drawings, FIG. 1 illustrates an ignition system 10 for an internal combustion engine. The ignition system 10 can be used with one of a number of types of internal combustion engines, including but not limited to light-duty combustion engines. The term ‘light-duty combustion engine’ broadly includes all types of non-automotive combustion engines, including two- and four-stroke engines used with hand-held power tools, lawn and garden equipment, lawnmowers, weed trimmers, edgers, chain saws, snowblowers, personal watercraft, boats, snowmobiles, motorcycles, all-terrain-vehicles, etc. As will be explained in greater detail and as shown in FIG. 2, the ignition system 10 can be a Transistor Controlled Ignition (TCI) system and include one of a number of control circuits, including the embodiment described in relation to FIG. 2.

With reference primarily to FIG. 1, ignition system 10 generally includes a flywheel 12 rotatably mounted on an engine crankshaft 13, a stator assembly 14 mounted adjacent the flywheel, and a control circuit 40 (FIG. 2) which is just one example of certain components that may be used within such a circuit and is not limiting to the disclosure herein which may use other components and other circuits. Flywheel 12 rotates with the engine crankshaft 13 and generally includes a permanent magnetic element having pole shoes 16, 18, and permanent magnet 17, such that it induces a magnetic flux in the nearby stator assembly 14 as the magnets pass thereby.

Stator assembly 14 may be separated from the rotating flywheel 12 by an air gap, and may include a lamination stack 24 having first and second legs 26, 28, a charge coil 30 and an ignition coil comprising primary and secondary ignition coils 32, 34. The lamination stack 24 may be a generally U-shaped, V-shaped or M-shaped (or other shapes) ferrous armature made from a stack of iron plates, and may be mounted to a housing (not shown) located on the engine. The charge coil 30 and primary and secondary ignition coils 32, 34 may all be wrapped around a single leg of lamination stack 24. Such an arrangement may result in a cost savings due to the use of a common ground and a single spool or bobbin for all of the coils. The ignition coil may be a step-up transformer having both the primary and secondary ignition coils 32, 34 wound around second leg 28 of the lamination stack 24. Primary ignition coil 32 is coupled to the control circuit, as will be explained, and the secondary ignition coil 34 is coupled to a spark plug 42 (shown in FIG. 2). Primary ignition coil 32 may have comparatively few turns of relatively heavy wire, while secondary ignition coil 34 may have many turns of relatively fine wire, if and as desired. The ratio of turns between the primary and secondary ignition coils 32, 34 generates a high voltage potential in the secondary coil 34 that is used to fire spark plug 42 or provide an electric arc and consequently ignite an air/fuel mixture in the engine combustion chamber.

The control circuit 40 is coupled to stator assembly 14 and spark plug 42 and generally controls the energy that is induced, stored and discharged by the ignition system 10. The term “coupled” broadly encompasses all ways in which two or more electrical components, devices, circuits, etc. can be in electrical communication with one another; this includes but is certainly not limited to, a direct electrical connection and a connection via an intermediate component, device, circuit, etc. The control circuit 40 can be provided according to one of a number of embodiments, including but not limited to the embodiment shown in FIG. 2.

Circuit 40 interacts with charge coil 30, primary ignition coil 32, and a kill switch 44, and generally includes a trigger coil 46, a switch 48, which may be a thyristor such as a silicon controlled rectifier (SCR) and a switch 50, which may be a transistor. A Zener diode 52 and resistor 54 may be connected in parallel to switch 50 to protect the switch from reverse current. The energy induced in coil 30 turns on the switch 50 and flows through the switch 50 and primary ignition coil 32. When the energy induced in trigger coil 46 is sufficient to change the state of the SCR 48 from off/nonconductive to on/conductive, the energy in the charge coil 30 flows through the SCR 48 and to ground. This causes a sudden change in current at the primary ignition coil 32 which induces a high voltage ignition pulse in secondary ignition coil 34. The ignition pulse travels to spark plug 42 which, assuming it has the requisite voltage, provides a combustion-initiating spark. Other ignition systems, including CDI and IDI systems, may be used.

Four-stroke engines operate with a cycle that includes four phases: intake, compression, power and exhaust. Fuel and air are taken into a combustion chamber of an engine cylinder during the intake phase, which generally occurs during a first downward or advancing stroke of a piston within the cylinder when the volume of the combustion chamber is increased. The fuel and air are mixed together and pressurized during the compression phase, which generally occurs during a first upward or retracting stroke of the piston when the volume of the combustion chamber is decreased. The power phase occurs after the fuel and air mixture is ignited by a spark from the spark plug 42 which may occur near or at a top dead center position of the piston, and the resulting combustion drives the piston downward for a second downward stroke in the engine cycle. Finally, exhaust gases are removed from the combustion chamber during the exhaust phase of the engine cycle, which may occur during or include a second upward stroke of the piston. This completes one engine cycle, and the subsequent engine cycle follows with the intake phase and continues to the exhaust phase as set forth above. Thus, the intake and compression phases may occur (generally) during a first revolution of the engine and the power and exhaust phases may occur during a second revolution of the engine in each engine cycle.

If the circuit 40 provides a spark from the spark plug 42 during each engine revolution, then only every other spark will cause an ignition event. The other spark event will occur after, or at the end of, the exhaust phase and there will not be a sufficient fuel charge in the combustion chamber to cause a combustion event. Thus, these sparks would be wasted and are unnecessary. To, among other things, avoid wasting the energy needed for the sparks and to permit that energy to be saved or used to power some other component or system, the method described below permits determination of the engine phase within an engine cycle in a four-stroke engine, so that the sparks can be limited to occurring in or after the compression phase, and not the exhaust phase.

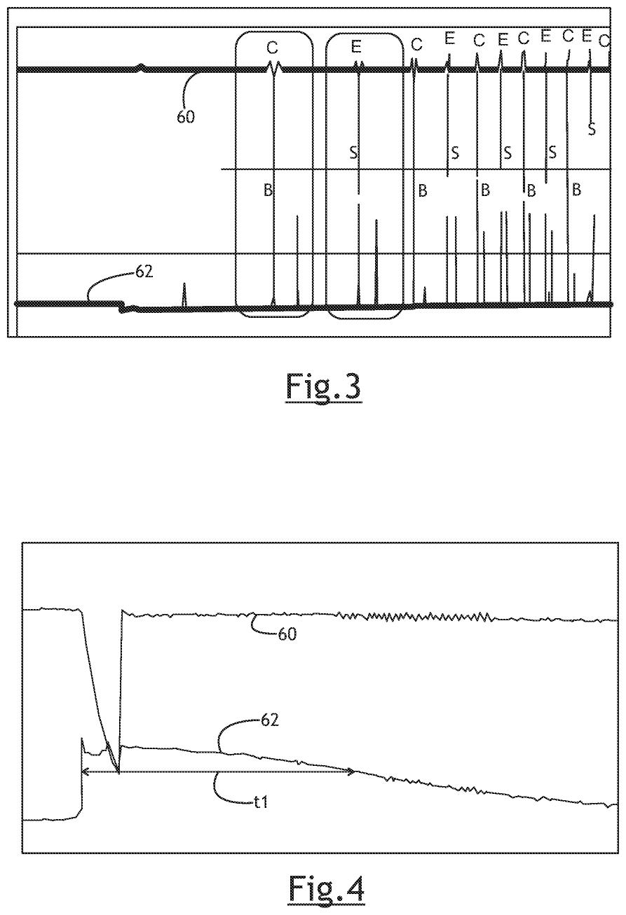

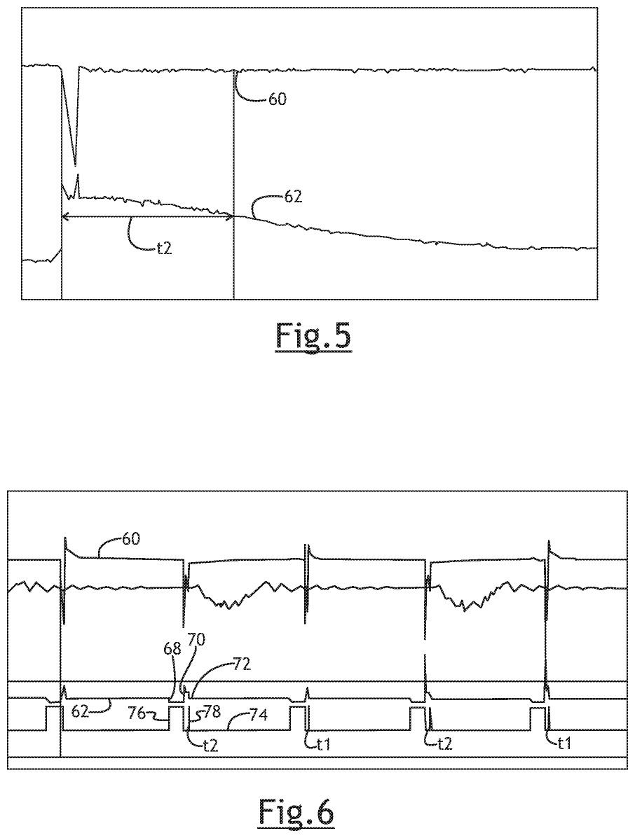

The graph in FIG. 3 shows in waveform 60 the voltage required to generate a spark at the spark plug 42 during each engine revolution in and engine having two cylinders, as well as a waveform 62 generated in the primary coil 32. FIG. 4 illustrates an enlarged view of a smaller portion of the waveforms 60, 62 during a compression phase of the engine cycle and FIG. 5 illustrates the waveforms 60, 62 during an exhaust phase of the engine cycle. It has been found that the voltage in the primary coil 32 required to cause a spark is different during the compression stroke than during the exhaust stroke of engine operation. While it may not be possible or easy, in at least some implementations, to monitor the required voltage at the spark plug 42 (e.g. the secondary coil voltage), the primary coil voltage can be monitored and is related to the secondary coil voltage. Therefore, monitoring the primary coil voltage can lead to information regarding the secondary coil voltage and the phase of the engine in which the spark is provided, such as is described below.

In at least some implementations, a threshold voltage may be set and the primary coil voltage may be compared to the threshold voltage. Differences between the primary coil voltage and the threshold voltage that occur in the compression and exhaust strokes can be examined or determined to enable determination of the engine phase in which a spark was provided. For example, the duration of time over which the voltage of the primary coil 32 is greater than the threshold voltage may be greater when the spark is provided during/after the compression stroke than during/after the exhaust stroke. This can be seen by comparison of FIG. 4 with FIG. 5, and by review of FIG. 6 which shows multiple engine strokes and cycles. In FIG. 4, the spark was provided during/after the compression stroke (i.e. was associated with the compression stroke) and the primary coil voltage was greater than or equal to the threshold voltage for a duration t1 of about 310 microseconds. The waveform 62 shown in FIG. 4 has been divided (e.g. by a factor of 100) to provide a more suitable voltage to the microprocessor for processing by the microprocessor. Accordingly, while the voltage across the primary coil 32 during a spark event may be between, for example, 300V to 400V, the threshold voltage considered by the microprocessor may be on the order of, for example, 2-10V, and in the example shown is 3V. In FIG. 5, the spark was provided during/after the exhaust stroke (i.e. was associated with the exhaust stroke) and the primary coil voltage was greater than or equal to the threshold voltage (again, 3V in this example) for a duration t2 of about 208 microseconds. At least one reason for this difference is that due to the higher pressure within the combustion chamber during the compression stroke, the voltage required to cause a spark is higher, for example, between 6,000 to 12,000V, than during the exhaust stroke which may be, for example, 2,000 to 3,000V. Accordingly, the voltage in the primary coil 32 may be higher for a longer period of time during the spark event associated with the compression phase than during the spark event associated with the exhaust phase. This difference in time above the threshold voltage can be used to determine in which engine phase a spark event has occurred.

FIGS. 6, 9 and 10 show that the spark duration is shorter for a spark event associated with the compression stroke (e.g. which may take place in the compression phase, before or at TDC of the compression stroke) than for a spark event associated with the exhaust stroke (e.g. which may take place in the exhaust phase, before or at TDC of the exhaust stroke). While the primary coil voltage may remain higher for a longer time for a spark associated with the compression phase, as shown in FIGS. 3-5, the total duration of the spark event is shorter for a spark event associated with the compression phase compared to the exhaust phase. The duration of the spark event can be seen as a function of the primary coil voltage during the spark event, such as is shown by waveform 62 in FIG. 6. In FIG. 6 it can be seen that the primary coil voltage is generally steady at a nominal value (e.g. 12 volts in one example of a battery powered ignition system) until the ignition dwell which causes a decrease in the voltage in the primary coil voltage at 68, followed by a rapid increase or spike up to, for example, 300V to 400V at 70 associated with the beginning of the spark event. When the spark event is over, the primary coil voltage returns to the nominal value at 72.

A syncing signal, shown by waveform 74 in FIG. 6, can be provided to the microprocessor that shows the duration of the spark event. In the example shown, the syncing signal is positive when the primary coil voltage is below the nominal value. This occurs during the ignition dwell period before the spark (shown at wave portion 76 in the syncing signal), and also briefly after the spark (shown by the spike 78). In the example shown, the syncing signal is provided as an output of about 4V to the microprocessor and is easily interpreted by the microprocessor. The spark duration is then associated with the time between when the primary coil voltage rises to and above the nominal value from a value less than the nominal value, to the time when the primary coil voltage drops below the nominal value after the spark event. The duration t1 between these times is less during the spark associated with the compression phase than the duration t2 during the spark associated with the exhaust phase. This difference permits determination of the phase in which a particular spark event occurred, and thus permits control of the phase in which a future spark event is provided to eliminate the wasted spark that would otherwise occur.

In at least some implementations, the difference in duration of the primary coil voltage over the threshold, as well as the different durations of the spark event, can be used to determine the engine phases and to cause a spark to occur only in the desired revolution or phase of engine operation. The voltage differences and event spark duration differences may occur and be detected at different engine speeds and during fluctuations of engine speed, that is, the differences can still be detected at various and varying engine speeds. Hence, the determination of engine phase as set forth herein can be made at different engine speeds and even if the engine speed is varying during the determination period. The determination can also be made in relatively few engine revolutions so it can be done quickly and efficiently. Other methods of trying to determine engine phases used differences in the speeds of the engine revolutions and are directly affected by varying engine speeds making the phase determination more difficult and generally requiring a greater number of engine revolutions to make the determination.

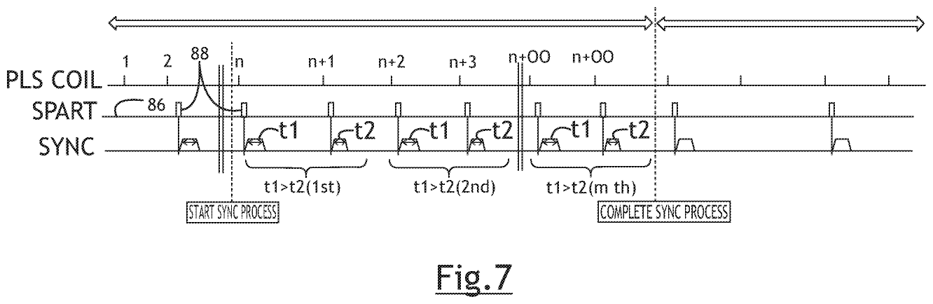

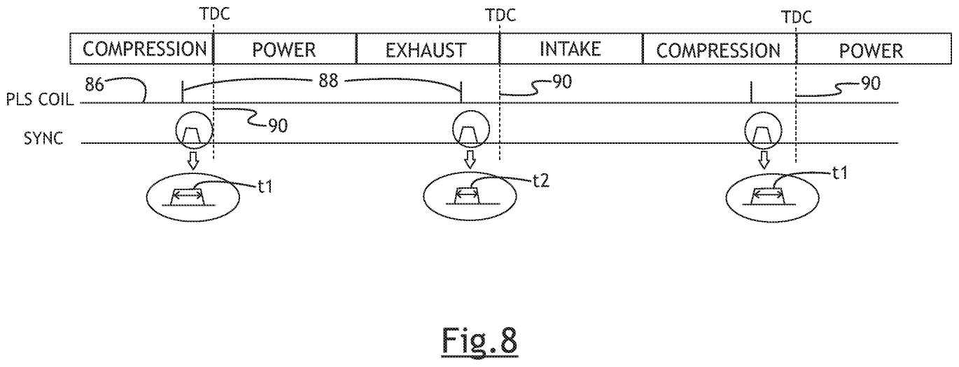

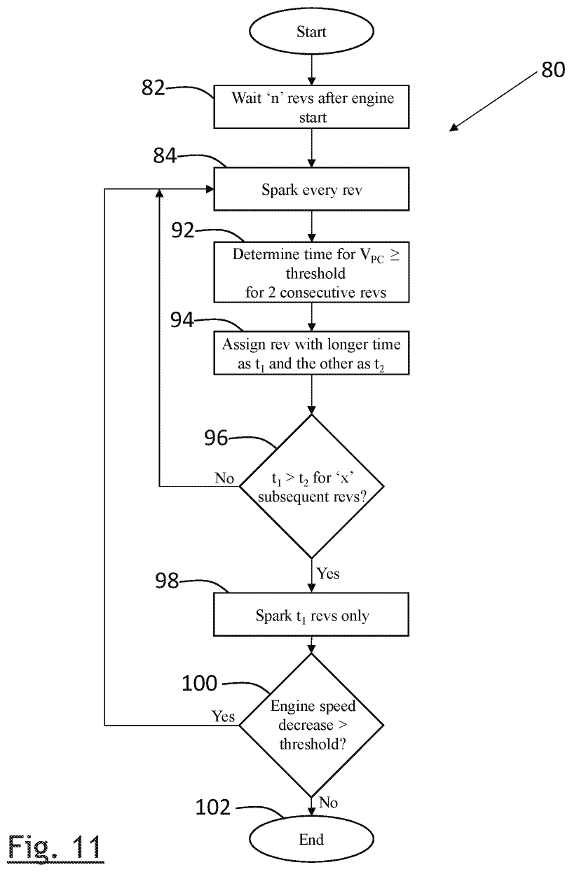

One method 80 for determining engine operating phases relative to spark events is generally shown in FIG. 11, and with reference to FIGS. 3-5, 7 and 8. In at least some implementations, the method 80 starts by waiting for a certain number ‘n’ of revolutions of the engine to occur after the engine has been started at 82. In at least some implementations, ‘n’ may be 2 or more revolutions. During initial engine operation and continuing when the method proceeds, a spark event is initiated during each revolution of the engine as noted at 84 in FIG. 11 and by line 86 in FIGS. 7 and 8. The sparks (numbered 88 in FIGS. 7 and 8) are generally associated with the compression and exhaust phases/strokes and occur near or at TDC 90 (FIG. 8) of the engine piston, as discussed above. This ensures that a spark is provided for the needed power phase to maintain engine operation. While a spark is also provided during the exhaust phase when a spark is not needed, this occurs for a limited number of revolutions as noted below.

The method 80 continues at 92, wherein the time that the primary coil voltage V_{PC} is above the threshold voltage for the first spark event after the method begins is compared to the time that the primary coil voltage V_{PC} is above the threshold voltage for the second spark event. In step 94, the spark event with the longer time duration may be set as t1 and the other spark event may be set as t2. As shown in FIG. 7, the spark events for a desired number of subsequent revolutions may be monitored with every second spark event from the spark designated t1 being related to the sparks associated with the compression phase, and the other spark events designated t2 being related to the exhaust phase. In step 96, when a certain number of revolutions, consecutive or otherwise, satisfy the relationship where the duration that the primary coil voltage V_{PC} is above the threshold voltage for t1 is greater than the duration that the primary coil voltage V_{PC} is above the threshold voltage for t2, then the method may proceed to step 98. In at least some implementations, the threshold number of revolutions is four, which relates to two engine cycles. Of course, other numbers of engine revolutions may be used, including fewer than or greater than four (e.g. between 1 and 30). In at least some implementations, the duration over which the primary coil voltage is greater than or equal to the threshold voltage is determined for multiple consecutive rotations and t1 is compared to t2 for each spark event to confirm the time differences noted and to facilitate positive determination of the engine phase(s).

In step 98, a spark is provided every other revolution and only during subsequent t1 revolutions, which should relate to the compression phase of the engine operation. The sparks are not provided in the t2 revolutions which should relate to the exhaust phase of engine operation. Then, in step 100, the engine speed is checked to ensure that the engine speed has not decreased by more than a threshold amount, within, for example, a certain time period or number of revolutions of providing the spark every other revolution. If the engine speed has decreased beyond the threshold, this could be a result of the method picking the wrong revolutions in which to provide the spark in which case no spark is being provided to support the combustion and power phase of engine operation. The method then returns to step 84 and a spark is provided during each revolution of the engine and then the method continues to determine the revolutions in which a spark should be provided as set forth above. If the engine speed does not decrease more than a threshold, then the method may end at 102 as the proper engine phase determination has been made and sparks are being provided during the proper revolution to support the engine power phase.

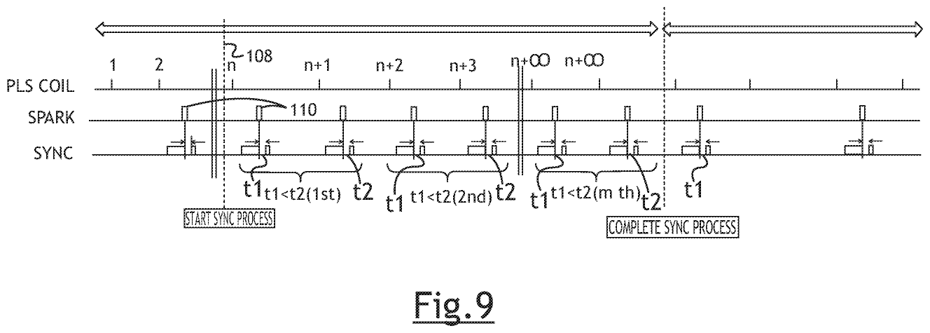

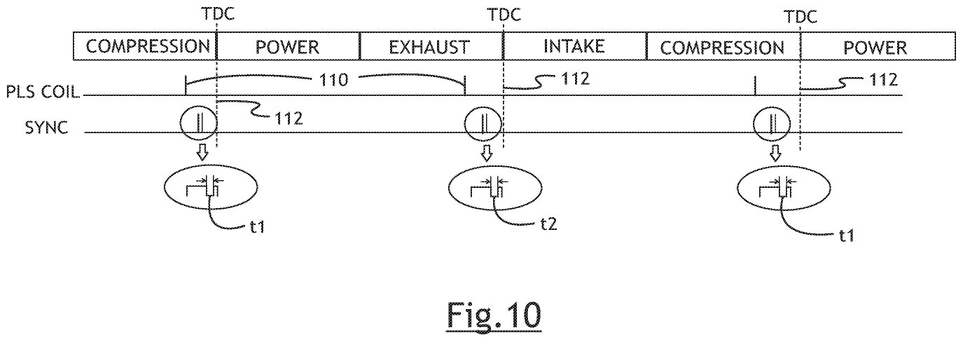

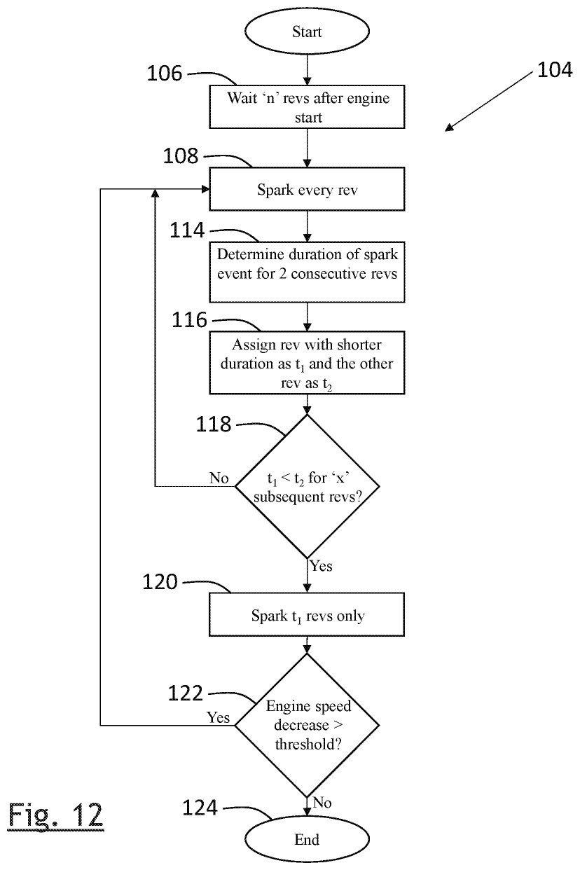

One method 104 for determining engine operating phases relative to spark events is generally shown in FIGS. 9,10 and 12. In at least some implementations, the method 104 starts by waiting at 106 for a certain number ‘n’ of revolutions of the engine to occur after the engine has been started. In at least some implementations, ‘n’ may be 2 or more revolutions. During initial engine operation and continuing when the method proceeds, a spark event is initiated during each revolution of the engine as noted at 108 in FIG. 12, and generally shown in FIGS. 9 and 10 by sparks 110. The sparks are generally associated with the compression and exhaust phases/strokes and occur near or at TDC 112 of the engine piston, as discussed above. This ensures that a spark is provided for the needed power phase to maintain engine operation. While a spark is also provided during the exhaust phase when a spark is not needed, this occurs for a limited number of revolutions as noted below.

At 114, the duration of the spark event for the first spark event after the method begins is compared to duration of the spark event for the second spark event. In step 116, the spark event with the shorter duration may be set as t1 and the other spark event may be set as t2. As shown in FIG. 9, the spark events for a desired number of subsequent revolutions may be monitored with every second spark event from the spark designated t1 being related to t1, and the other spark events related to t2. In step 118, when a certain number of revolutions, consecutive or otherwise, satisfy the relationship where the duration for t1 spark events is less than the duration for t2 spark events, then the method may proceed to step 120. In at least some implementations, the threshold number of revolutions is four, which relates to two engine cycles. Of course, other numbers of engine revolutions may be used, including fewer than or greater than four (e.g. between 1 and 30).

In step 120, a spark is provided every other revolution and only during subsequent t1 revolutions, which should relate to the compression phase of the engine operation. The sparks are no longer provided in the t2 revolutions which should relate to the exhaust phase of engine operation. Then, in step 122, the engine speed is checked to ensure that the engine speed has not decreased by more than a threshold amount, within, for example, a certain time period or number of revolutions of providing the spark every other revolution. If the engine speed has decreased beyond the threshold, this could be a result of the method resulting in the wrong revolutions being chosen in which to provide the spark in which case no spark is being provided to support the combustion and power phase of engine operation. The method then returns to step 108 and a spark is provided during each revolution of the engine and then the method continues to determine the revolutions in which a spark should be provided as set forth above. If the engine speed does not decrease more than a threshold at 122, then the method may end at 124 as the proper engine phase determination has been made and sparks are being provided during the proper revolution to support the engine power phase.

In at least some implementations, at least one characteristic of the primary coil voltage for a spark event associated with the compression phase of engine operation is different than for a spark event associated with the exhaust phase of engine operation. Accordingly, detection or determination of the difference for one or more engine cycles may permit determination of the proper engine operating phase in which a spark is needed for combustion of a fuel mixture in the engine. In at least some implementations, the characteristic includes one or both of: 1) the duration of the spark event as determined by certain changes in the primary coil voltage, and 2) the duration that the primary coil voltage is above a threshold voltage. Either or both of these characteristics may be used to enable engine phase determination sufficient to permit elimination of unnecessary spark events associated with the engine exhaust phase. At least some methods of controlling the spark events in an engine may include checking a certain number of subsequent engine revolutions to ensure the characteristic is demonstrated as expected during the spark events for the subsequent engine revolutions. If the characteristic is as expected in subsequent engine revolutions, then the spark is provided every other revolution and only during those revolutions associated with the engine compression and power phases. The methods may make this determination after a relatively low number of revolutions so the method may quickly and easily determine the engine phase in which a spark event is needed to reduce wasted energy and improve the efficiency of the system. Further, the characteristic(s) of primary coil voltage used to determine the engine phase may occur (e.g. satisfy the relationships t1>t2 or t1<t2) at different engine speeds and even if the engine speed changes between engine revolutions. Accordingly, the method can be effective even during initial engine operation when the engine may be warming up and not running smoothly, that is, the engine speed may be more erratic from one revolution to the next.

A method of controlling spark events in a combustion engine, comprising:

determining for at least two engine revolutions in a four-stroke engine at least one characteristic of the primary coil voltage for a spark event;

determining, based upon the characteristic of the primary coil voltage, which of the spark events is associated with a compression phase of engine operation and which of the spark events is associated with an exhaust phase of engine operation; and

providing spark events in subsequent engine revolutions that are associated with the compression phase of engine operation but not in revolutions associated with the exhaust phase of engine operation. In at least some implementations, the characteristic includes one or both of: 1) the duration of the spark event as determined by certain changes in the primary coil voltage, and 2) the duration that the primary coil voltage is above a threshold voltage.

Some engines include more than one cylinder to which a fuel and air mixture is provided from a single source, such as a single carburetor or fuel injector or fuel control valve (such as a solenoid carried by a throttle body or other device to which fuel is provided). In at least some examples, the engine includes two cylinders. It can be difficult to provide a fuel and air mixture having a proper fuel-to-air ratio to both cylinders consistently during operation of the engine at various speeds and under various conditions. Sometimes the engine runs roughly or stalls due to an improper fuel and air mixture provided to one or both cylinders of the engine.

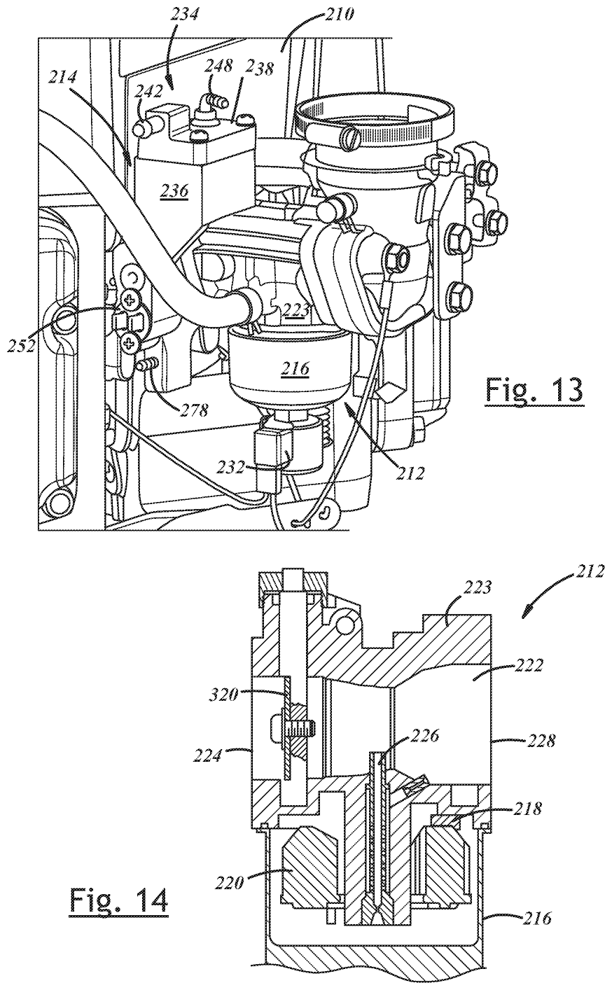

Referring in more detail to the drawings, FIG. 13 illustrates a combustion engine 210, a first fuel supply device 212 that supplies a fuel and air mixture to the engine, and a second fuel supply device 214 that selectively supplies fuel to the engine. The engine 210 may be a light-duty combustion engine which may include, but is not limited to, all types of combustion engines including two-stroke, four-stroke, carbureted, fuel-injected, and direct-injected engines. Light-duty combustion engines may be used with hand-held power tools, lawn and garden equipment, lawnmowers, grass trimmers, edgers, chain saws, snowblowers, personal watercraft, boats, snowmobiles, motorcycles, all-terrain-vehicles, etc.

In the example shown in FIGS. 13 and 14, the first fuel supply device is a carburetor 212. While the carburetor 212 may be of any desired type, including (but not limited to) diaphragm carburetors, rotary valve carburetors and float bowl carburetors, the example shown in FIGS. 13 and 14 is a float bowl carburetor. The carburetor 212 may include a fuel bowl 216 in which a supply of fuel is maintained, an inlet valve (shown diagrammatically at 218) that controls fuel flow into the fuel bowl and a float 220 in the fuel bowl that actuates the inlet valve 218. The carburetor 212 may further include a first passage, which may be called a fuel and air mixing passage 2222, formed in a main body 223 and having an inlet 224 through which air flows, a fuel passage 226 through which fuel from the fuel bowl flows and an outlet 228 through which a fuel and air mixture flows for delivery to the engine 210. A throttle valve 230 may be rotatably received in the fuel and air mixing passage 222 to control the flow rate of fluid in and through the carburetor 12. The fuel bowl 216 of the carburetor 212 may be constructed and arranged as set forth in U.S. patent application Ser. No. 13/623,943, filed Sep. 12, 2012, and may include a fuel shutoff solenoid 232 (FIG. 13) with or without any accelerator pump as set forth in that application. The carburetor 212 may also be constructed and arranged as set forth in U.S. Pat. No. 7,152,852 with or without a priming pump as set forth therein. The noted application and patent being incorporated herein by reference in their entireties.

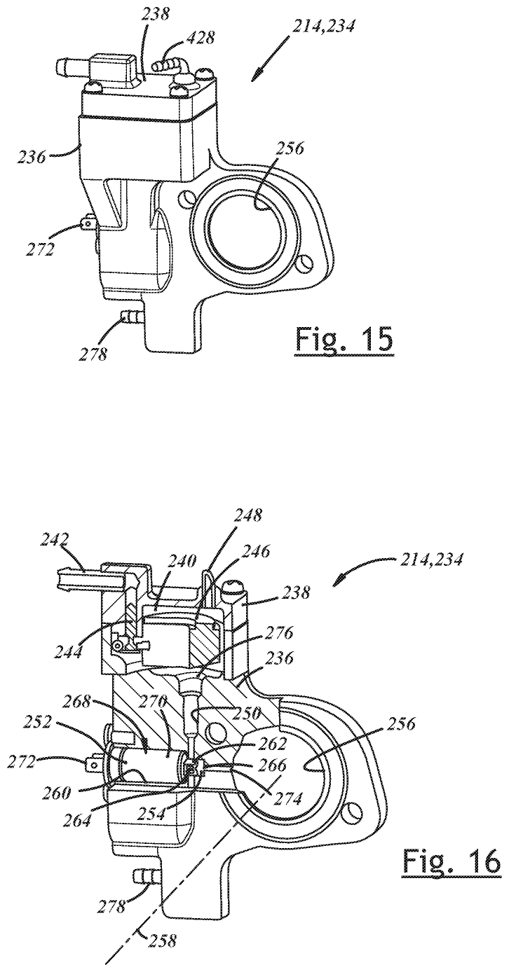

In at least some implementations, and as shown in FIGS. 13, 15 and 16, an insulator 234 is provided between the carburetor 212 and the engine 210 with appropriate gaskets or seals between them. The insulator 234 may include or define the second fuel supply device 214 and may include a main body 236 and a cover 238 connected to the main body. As shown in FIG. 16, the fuel chamber 240 is defined between the cover 238 and main body 236 and a fuel inlet 242 communicates with the fuel chamber. To control the flow of fuel into the second fuel supply device/insulator 234, a valve 244 is associated with the fuel inlet 242. For example, the valve 244 may close to prevent fuel from entering the fuel chamber 240 and may open to permit fuel to flow into the fuel chamber. In the example shown, the valve 244 is coupled to and actuated by a float 46 received within the fuel chamber 240. The float 246 is responsive to changes in the level of fuel in the fuel chamber 240 (e.g. it may be buoyant in the fuel) to selectively open and close the valve 244 and fuel inlet 242. When the level of fuel in the fuel chamber 240 is at a desired maximum level, the float 246 moves the valve 244 into engagement with a valve seat and fuel flow into the fuel chamber 240 is inhibited or stopped altogether. Fuel vapor or air within the fuel chamber 240 may be vented therefrom through an outlet 48 which may be communicated with or lead to a vapor canister which may contain an adsorbent material (e.g. activated charcoal) arranged to limit or prevent the emission of hydrocarbons to the atmosphere. In this way, the fuel chamber 240 may also function as a fuel vapor separator. The insulator 234 may be made from a polymeric or metal material, such as but not limited to, engineering plastics like phenol formaldehyde (PF), polyphenylene sulfide (PPS), polybutylene terephthalate (PBT), polyether ether ketone (PEEK), or aluminum or other metals.

The insulator 234 may further include a fuel passage 250 leading from the fuel chamber 240 to a fuel control valve 252. The fuel passage 250 may be formed in the main body 236, the cover 238 or in a conduit extending externally of the main body and cover, or any combination of these. In the example shown, the fuel passage 250 is formed in the main body 236 and extends through a valve seat 254 of the control valve 252 and to a fluid passage 256, sometimes called a second passage, formed through the main body 236. The valve seat 254 may be annular and arranged to be engaged by a valve head of the control valve 252 to selectively allow and prevent fuel flow through the valve seat and hence, from the fuel chamber 240 to the fluid passage 256. The fluid passage 256 may be aligned and communicated with the first passage/fuel and air mixing passage 222 of the carburetor 212. The body 223 of the carburetor 212 may be engaged with the isolator 234 so that the outlet or downstream end of the fuel and air mixing passage 222 is communicated with the fluid passage 256 and the fuel and air mixture discharged from the fuel and air mixture passage flows through the fluid passage 256 before entering the engine 210. That is, within the flow path from the carburetor 212 to the engine 210, the isolator 234 may be downstream of the carburetor and upstream of the engine. Annular gaskets or seals may be provided between the carburetor 212 and the insulator 234, surrounding the fluid passage 256 and fuel/air mixing passage 222. The main body 236 of the isolator 234, in the area of the fluid passage 256 may be relatively thin in the direction of an axis 258 of the fluid passage 256. The isolator 234 may separate the carburetor 212 from the engine 210, to, for example, isolate the carburetor from heat and vibrations of the engine and permit the carburetor to function better (e.g. by reducing vaporization of fuel in the carburetor and by damping engine vibrations that may affect movement of valves, diaphragms and the like in the carburetor).

The fuel control valve 252 may be received within a cavity 260 in the main body 236 that intersects or is open to the fuel passage 250, for example, at the valve seat 254. When the valve head is closed on the valve seat, fuel is inhibited or prevented from flowing to the fluid passage 256 and when the valve head is off the valve seat, fuel may flow from the fuel chamber 240 to the fluid passage 256 for delivery to the engine 210. The control valve 252 may have an inlet 262 to which fuel is delivered, a valve element 264 (e.g. valve head) that controls fuel flow rate and an outlet 266 downstream of the valve element. To control actuation and movement of the valve element 264, the control valve 252 may include or be associated with an electrically driven actuator such as (but not limited to) a solenoid 268. Among other things, the solenoid 268 may include an outer casing 270 received within the cavity 260 in the main body 236, an electrical connector 272 arranged to be coupled to a power source to selectively energize an internal wire coil to slidably displace an internal armature that drives the valve element 264 relative to the valve seat 254. The solenoid 268 may be constructed as set forth in U.S. patent application Ser. No. 14/896,764, filed Jun. 20, 2014 and incorporated herein by reference in its entirety. Of course, other metering valves, including but not limited to different solenoid valves or commercially available fuel injectors, may be used instead if desired in a particular application.

In at least some implementations, the fuel chamber 240 is above (relative to the force of gravity) the valve seat 254 and above the location of a fuel passage outlet port 274 (i.e. the juncture of the fuel passage 250 with the fluid passage 256) such that fuel flows from the fuel chamber 240 to the fluid passage 256 under the force of gravity and any head or pressure of the fuel within the fuel chamber itself. Hence, the fuel flows under low pressure rather than a higher pressure such as may be caused by a pump acting on the fuel. Further, the fuel inlet 242 may be located above an outlet 276 of the fuel chamber 240 (relative to the force of gravity), and the inlet valve 244 may engage a valve seat located between the inlet 242 and outlet 276 of the fuel chamber 240 such that the valve 244 is located internally of the fuel chamber 240 and generally between the main body 236 and cover 238 in at least some implementations.

In at least some implementations, the fuel from the fuel chamber 240 is not needed to support engine operation in at least some, and up to most, engine operating conditions under which fuel from the carburetor 212 is sufficient to support engine operation. However, the fuel control valve 252 may be selectively opened to provide to the engine 210 fuel from the fuel chamber 240 under certain engine operating conditions. For example, fuel in addition to that provided by the carburetor 212 may be desirable in some applications to facilitate starting a cold engine and to help warm-up the engine. In some applications, fuel may be provided to support engine acceleration or to smooth out engine deceleration or to slow an engine operating at too high of a speed, etc. This additional fuel is provided downstream of the carburetor 212, which may be the first or primary source of fuel for the engine 210. Further, this additional fuel may be provided without a pump, which considerably reduces the cost and complexity of the system while still supporting a wide range of engine operating conditions.

To facilitate draining the fuel chamber 240 and fuel passage 250, the insulator 234 may include a drain outlet 278 that is downstream of the valve seat 254. That is, the valve seat 254 is located between the fuel chamber 240 and the drain outlet 278 with respect to fuel flow from the fuel chamber to the drain outlet. Fuel may be drained to, for example, reduce emissions from the fuel chamber 240, and inhibit or prevent fuel from splashing or spilling out of the fuel chamber as the device that includes the engines is moved or transported while the engine 210 is not operating, and to reduce corrosion or deterioration of components otherwise in contact with the fuel. The drain outlet 278 may be defined in a fitting coupled to the insulator body 236, and a suitable valve may be provided to prevent unintended fuel drain, if desired.

When the fuel control valve 252 is opened and the duration of time that the fuel control valve is opened may be controlled by a suitable controller, such as a microprocessor (e.g microcontroller 46). The microprocessor 46 may include any suitable program, instructions or algorithms to determine when the valve 252 should be opened and when the valve should be closed. Further, control of the valve 252 may be dependent upon engine operating conditions, such as engine speed, which may be determined by one or more sensors or other components. In at least some examples, such as is diagrammatically illustrated in FIG. 1, a flywheel 12 is rotated by the engine 210 and one or more magnets or magnetic elements 16-18 are fixed to the flywheel and are rotated relative to one or more wire coils 30, 32, 34 as the flywheel is rotated. Passing the magnets/magnetic elements 16-18 by the coils 30-34 generates electricity in the coils which may be used for one or more purposes, including but not limited to, generating a spark for ignition, providing power to the controller/processor, generating power for the fuel control valve 252 and to provide a signal indicative of engine speed (e.g. a VR sensor, which may be comprised of a wire coil).

The coils 30, 32, 34, which may include the VR sensor, provide a signal or voltage variance in accordance with the position and movement of the magnets 16-18 relative to the coils, and the position of the magnets can be related to the position of the engine 210 within an engine rotation and the time for an engine rotation depends upon the engine speed. In this way, the VR sensor and/or one or more other coils may be monitored to determine engine speed which may be used to control, at least in part, the operation of the fuel control valve 252. In some implementations, the fuel control valve 252 is opened to support initial idle engine operation, or engine operation above idle intended to warm-up the engine. Once the engine speed increases beyond a threshold, the fuel control valve 252 is closed and the engine operation is supported by the fuel and air mixture delivered to the engine 210 by the carburetor 212. If the fuel control valve 252 is used to provide supplemental fuel to the engine 210 during engine acceleration, then the increasing engine speed between engine revolutions can also be detected in the same way and the fuel control valve opened as a result. The ignition and VR coils noted herein are often provided in engine fuel systems that do not have the fuel control valve 252 as set forth herein so these components do not represent additional cost in the system and the fuel control valve can be controlled with components already in existence.

The fuel control valve 252, while described as being carried by an insulator downstream of the carburetor, could instead by carried by the carburetor to selectively provide a supplemental or increased amount or flow rate of fuel form the carburetor (or fuel injector or throttle body, etc). To permit improved control of the flow of fuel to the engine cylinders, the fuel control valve 252 can be selectively opened to coincide with a desired portion of the engine cycle for each cylinder of the engine. In at least some implementations, the fuel control valve is opened to provide fuel to the engine cylinders during or in support of at least some intake cycles of each cylinder without requiring an intake manifold pressure sensor to positively detect the manifold pressure associated with an intake event. Further, in at least some implementations, the fuel control valve is not actuated for every engine cycle of both cylinders, but may be actuated to support less than every engine cycle to reduce the response time required for actuation of the fuel control valve while still providing sufficient fuel to improve engine stability. For example, the fuel control valve may be actuated to support every other, every third or even fewer engine cycles (e.g. every fourth cycle, every fifth cycle, every seventh cycle, etc), as desired.

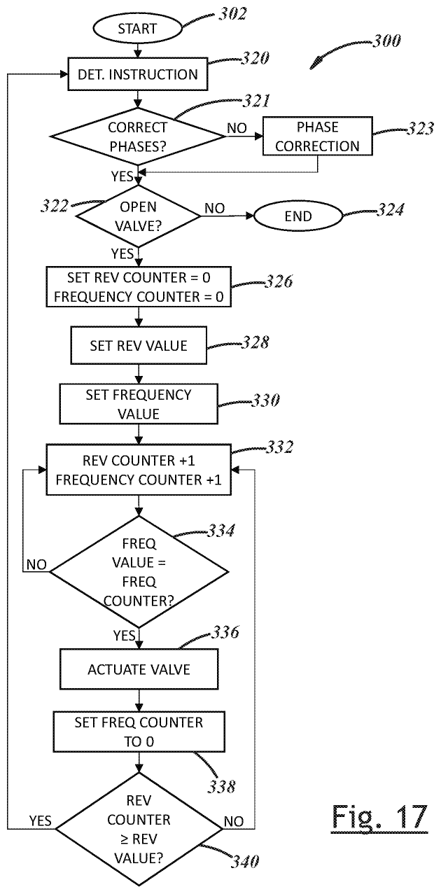

To control actuation of the fuel control valve, a control process or method, such as is set forth above, may be used to determine the various engine cycles of each cylinder and then the fuel control valve actuation may be coordinated with the engine operation according to certain parameters. One method 300 is shown in FIG. 17 and begins at 302, after a determination has been made as to various engine cycle phases for one or both (or more) cylinders. That is, a process such as is set forth above may be used to determine the phases, for example intake and exhaust, for one or more cylinders. After that determination is made, ignition system pulses, for example from the VR sensor, ignition timing pulses or otherwise, are monitored and assigned to or associated with four phases, generally called A, B, C and D.

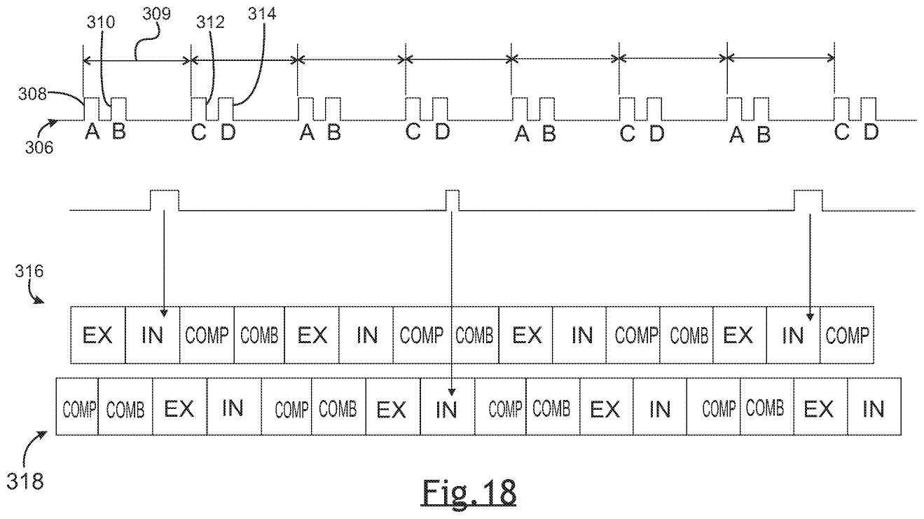

FIG. 18 shows certain plots as they relate to a V-twin four-stroke engine. That is, the engine has two cylinders in a “V” arrangement, and operates with four-strokes per engine cycle, which occurs over two engine revolutions. In general, phases A, B, C and D correspond to the ignition events in the engine, which are schematically shown in line 306 in FIG. 18, and phases A, B, C and D are labeled beneath line 306. A first ignition event 308 occurs in a second cylinder and corresponds to phase A, a first ignition event 310 in a first cylinder corresponds to phase B, a second ignition event 312 in the second cylinder corresponds to phase C and a second ignition event 314 in the first cylinder corresponds to phase D. This completes one full engine cycle for each cylinder, and one engine revolution, as noted at 309 in FIG. 18. Thereafter, phases A-D occur for the subsequent engine revolutions as shown. In such an arrangement, an engine ignition event occurs twice for each cycle in each cylinder, but only one ignition event leads to the combustion phase and the other ignition event is essentially wasted. As noted above, the wasted ignition event can be skipped, if desired, and then the timing of the fuel control valve actuation may be controlled as a function of a different signal, such as a signal from a different coil.

In more detail, in each cylinder a first ignition event occurs during or right after the compression phase and results in combustion for the power phase of the engine cycle, and a second ignition event occurs during or right after the exhaust phase and before the intake phase and does not result in a combustion event. In the V-twin arrangement, the phases of each cylinder are offset from each other, as shown by the block layout including row 316 showing the phases of the first cylinder and row 318 showing the phases of the second cylinder. The first ignition event in one cylinder closely follows a second ignition event of the other cylinder, and then a certain time elapses until the next two ignition events (one per cylinder), as shown by line 306. In FIG. 18, the first cylinder begins with the exhaust phase, and the second cylinder begins with the compression phase, and each block represents one phase for a given cylinder.

The process continues to step 320 in which an instruction with regard to the actuation of the fuel control valve 252 is determined. Various engine operating conditions, parameters or variables may be considered in step 320, including but not limited to: 1) the number of engine revolutions are tallied from a set point such as engine starting, for example, by counting the number of A and C phases since the engine was started, or the time since the engine was started is determined or tracked; 2) the engine speed is determined, for example, by measuring the time from phase A to C or C to A of a cylinder; and 3) the engine cylinder temperature is determined, for example, with an engine mounted temperature sensor. In at least some implementations, data is stored in memory accessible by the microcontroller and that data includes instructions or is otherwise usable by the microcontroller to determine when to actuate or open the fuel control valve to provide fuel therethrough, and for what duration of time the fuel control valve 252 should be actuated. The data may be in any suitable form, including but not limited to a look-up table, map, algorithm or otherwise.

Based on this data, a fuel control valve instruction is or instructions are provided or determined that control whether the fuel control valve 252 should be opened, if so, when the valve should be opened and the duration for which the valve should be opened. In at least some implementations, the valve 252 may be opened once per engine revolution or less frequently, for example, every second, third, fourth, fifth, etc, engine revolution.

The engine temperature and engine speed data, as well as the number of engine revolutions since the engine was started may all be used to inform or determine the fuel control valve instruction. For example, a colder engine may require more fuel to facilitate warming-up the engine and so the instruction may be to open the fuel control valve 252 more frequently and/or for a greater duration when the engine temperature is lower than when the engine temperature is higher. As another example, an engine that has recently been started may require more fuel to facilitate maintaining initial engine operation and/or providing a steadier initial operation of the engine. Thus, the fuel control valve 252 may be opened more frequently and/or for a greater duration when the engine revolution counter indicates a lower value than when it indicates a higher value.

And the engine speed may be used to determine if and when to actuate the control valve. In at least some implementations, if the engine speed is lower than desired idle engine speed, then more fuel may be added to facilitate or improve engine idle operation. In at least some implementations, if the engine speed is higher than in one or more previous cycles, it may be determined that the engine is accelerating and additional fuel may be desired to support engine acceleration. In that case, the fuel control valve 252 may be instructed to open, or to open more frequently than it otherwise would be opened and/or the valve may be opened for a greater duration during at least some of the times it is actuated during acceleration of the engine. Of course, these are just representative examples of when the fuel control valve 252 may be opened and factors that may be considered in determining when to open the valve and for what duration the valve should be opened during each actuation.

After the fuel control valve instruction is determined, the method 300 may continue to step 321 in which the phase determination is verified, such as by repeating the above described method to determine again the cylinder phases, to ensure that the further method steps are implemented during the desired phases for the engine cylinders. If the actual phases determined in step 321 are as previously determined, then the method continues to step 322. If the actual phases as determined in step 321 are not as previously determined, then this error is corrected in step 323 so that the further method steps are performed with the correct engine phases and then the method continues to step 322.

In step 322, it is checked whether the fuel control valve 252 should be further actuated or if the process should end at 324. If the fuel control valve instruction indicates that the fuel control valve is to be actuated, the process continues to step 326 in which a REV counter is set to zero and a FREQUENCY counter is also set to zero. Next, in step 328, a REV value is set in accordance with the number of revolutions over which the same fuel control valve instruction should be implemented. For example, if the instruction is to be implemented for the next 40 engine revolutions, then the REV value would be set to 40. Next, in step 330, a FREQUENCY value is set in accordance with the frequency at which the fuel control valve should be actuated. For example, if the fuel control valve 252 is to be actuated every engine revolution then REV value may be set to 1, if every other revolution then REV value may be set to 2, if every third revolution then REV value may be set to 3, and so on. Then, in step 332, the REV counter is incremented by one, and the FREQUENCY value is incremented by one. In step 334 the FREQUENCY value is checked to see if it is equal to the FREQUENCY counter. If not then the method returns for the next engine revolution to step 332 in which the counters are incremented by one, because the current engine revolution is not one in which the fuel control valve 252 should be actuated. If in step 334 the FREQUENCY value is equal to the FREQUENCY counter, then the method proceeds to step 336 in which the fuel control valve 252 is actuated as the current engine revolution is one in which the fuel control valve should be actuated in accordance with the fuel control valve instruction. Thereafter, in step 338, the FREQUENCY counter is set to zero. Finally, in step 340, the REV counter value is checked against the REV value to determine if the number of engine revolutions since the fuel control valve instruction was determined is equal to the total number of revolutions during which the instruction was to be performed. If yes then the method returns to step 320 so that a new fuel control valve instruction can be determined in view of the then current engine operating conditions (e.g. total number of revolutions, speed and temperature). If no then the method returns to step 332 in which the REV and FREQUENCY counters are incremented so that the existing fuel control valve instruction is performed for the next engine revolution and eventually for the total desired number of engine revolutions.

Optionally, the engine temperature and/or engine speed may be checked again before returning to step 332, to ensure that the temperature is not above a threshold at which fuel should not be added and/or the engine speed is not outside of one or more thresholds. If a temperature or engine speed check determines that the fuel control valve instruction should change, the method may return to step 320 in which the desired parameters are checked and a fuel control valve instruction is determined. Such temperature and engine speed checks can be performed as often as desired to monitor system performance.

As shown in FIG. 18, when the fuel control valve is opened every three revolutions, it may be opened a first time at a time corresponding to the intake phase of the first cylinder, a second time corresponding to the intake phase of the second cylinder, and so on. The duration that the fuel control valve is opened may be changed to provide more fuel to one cylinder than the other cylinder. In the example shown, the fuel control valve is opened for a longer period of time every other actuation to provide more fuel to the first cylinder than to the second cylinder. Of course, the fuel control valve instruction could provide any desired duration for the fuel control valve opening including, but not limited to the same opening duration for each cylinder, different durations for the cylinders, or different durations for different actuations of the valve corresponding to the intake phases of one or both cylinders. For example, the first cylinder could receive more fuel during a first actuation associated with the first cylinder and less fuel the next actuation associated with the first cylinder. Further, fuel may be provided from the fuel control valve to only one cylinder by actuating the fuel control valve only in correspondence with the intake phase of that cylinder. Hence, the fuel control valve can be used to provide supplemental fuel to one or both of the cylinders, and the fuel delivery can be different between the cylinders and can be provided as a function of one or more engine operating conditions such as temperature, engine speed and number of engine revolutions since the engine has been started.

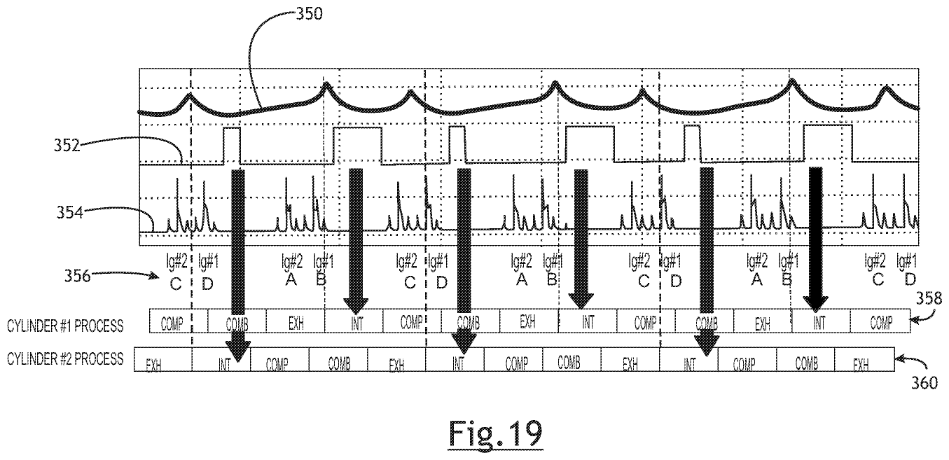

In FIG. 19, an engine intake manifold pressure signal is shown at line 350, although this is for illustrative purposes and an engine intake manifold pressure sensor is not needed. The fuel control valve actuation signal is shown at line 352, the ignition system pulses or signals are shown at line 354, the ignition phases A, B, C, D are shown at 356 and the engine cycle phases are shown in row 358 for the first cylinder and row 360 for the second cylinder. In FIG. 19, the first phase shown in row 358 for the first cylinder is compression and the first phase shown in row 360 for the second cylinder is exhaust. In this example, the fuel control valve 252 is opened each engine revolution, which alternately opens the valve during the intake phase for each engine cylinder. Relative to ignition phases A, B, C and D, the control valve 252 is opened alternately corresponding to or associated with phases B and D. In this example, the fuel control valve is opened for a longer period of time corresponding to or associated with the intake phase for the first cylinder (ignition phase B) than for the second cylinder.

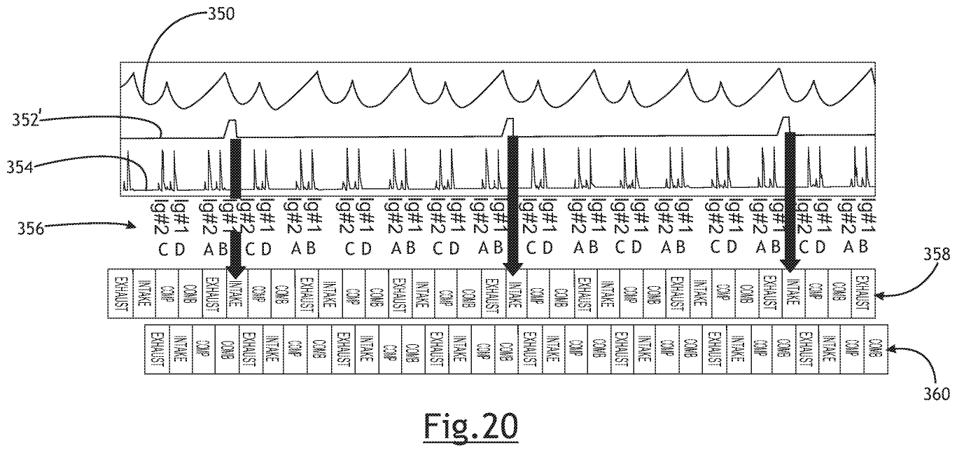

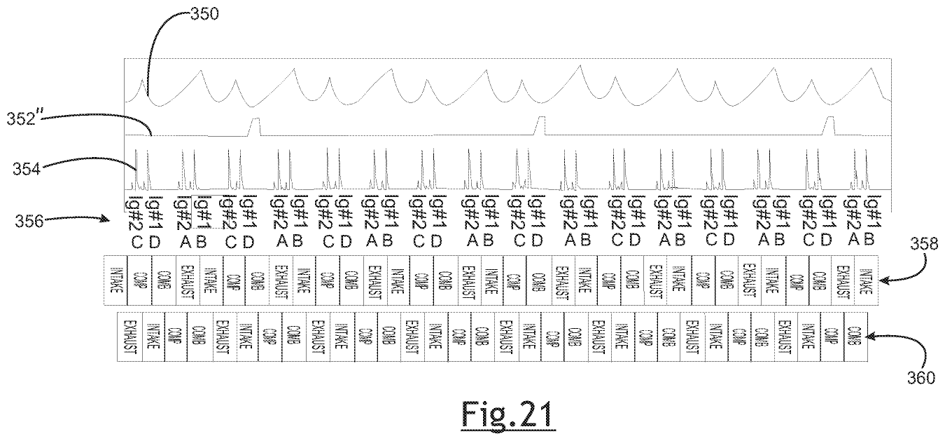

FIGS. 20 and 21 are similar to FIG. 19 and the same reference numerals used in FIG. 19 are used in FIGS. 20 and 21 to indicate the similar plot lines and rows shown in these figures. In FIG. 20, the fuel control valve 252 is opened is opened every sixth engine revolution as shown by plot 352′, corresponding to or associated with the intake phase for the first cylinder (ignition phase B) to provide fuel to the first cylinder. Also, in FIG. 20, the first phase shown for the first cylinder in row 358 is the exhaust phase and the first phase shown for the second cylinder in row 360 is also the exhaust phase. In FIG. 21, the fuel control valve 252 is opened is opened every sixth engine revolution as shown by plot 352″, corresponding to or associated with the intake phase for the second cylinder (ignition phase D) to provide fuel to the second cylinder. Also, in FIG. 21, the first phase shown for the first cylinder in row 358 is the intake phase and the first phase shown for the second cylinder in row 360 is the exhaust phase.

The fuel control valve instruction may vary according to various engine operating parameters or conditions, including but not limited to, engine speed, engine temperature and the number of revolutions or time since the engine was started. In one implementation, when the engine is started and the engine temperature is below −22.5 Celsius, the engine may run in a first phase for a set number of engine revolutions, such as 30, to establish initial engine operation. For the second phase which in this example includes 10 engine revolutions, the fuel control valve may be opened each revolution for 40 milliseconds. For the third phase which includes the following 160 engine revolutions, the actuation of the fuel control valve may, if desired, vary by engine speed or the actuation may be the same for any engine idling speeds (e.g. low speed, low load operation the particular values of which will vary by engine type or size, with one example being between 2,250 and 3,500 rpm). In one example, the control valve is opened for 15 milliseconds every revolution during this third phase. Thereafter, the fuel control may be provided as desired for a fourth phase with one example being 36,000 revolutions in which the fuel control valve is opened for 5 milliseconds every fifth revolution. Of course, other revolutions, opening durations and actuation schedules may be used, as desired for a particular engine.

If the engine was between −5 Celsius and −12.5 Celsius when started, the first phase might last for fewer revolutions, for example 20 revolutions instead of 30 revolutions, the second phase might include only 6 revolutions in which the fuel control valve is opened for a predetermined time, such as 40 milliseconds, the third phase might include fewer revolutions than for a colder engine, for example, 40 revolutions instead of 160 revolutions and the valve may be opened for 8 milliseconds instead of 15, and the fourth phase may include about 20,000 rpms during which the fuel control valve is opened for 4 milliseconds every fifth revolution. A warm engine started at 30 Celsius may have a first phase of 15 revolutions, a second phase of 5 revolutions in which the valve is opened for 40 milliseconds every revolution, a third phase of 20 revolutions during which the valve is opened for 4 milliseconds every revolution, and a fourth phase of only about 3,500 revolutions in which the valve is opened for 3 milliseconds every seventh revolution.

Of course, the number of phases, the number of revolutions in each phase, and the fuel control valve actuation in each phase may be adjusted as desired. Further, any number of engine temperatures and engine speed thresholds may be used to provide different instructions within the control methods at any temperature or temperature range to permit improved customization of the fuel control valve actuation that may be useful for a wide variety of engines and engine applications.

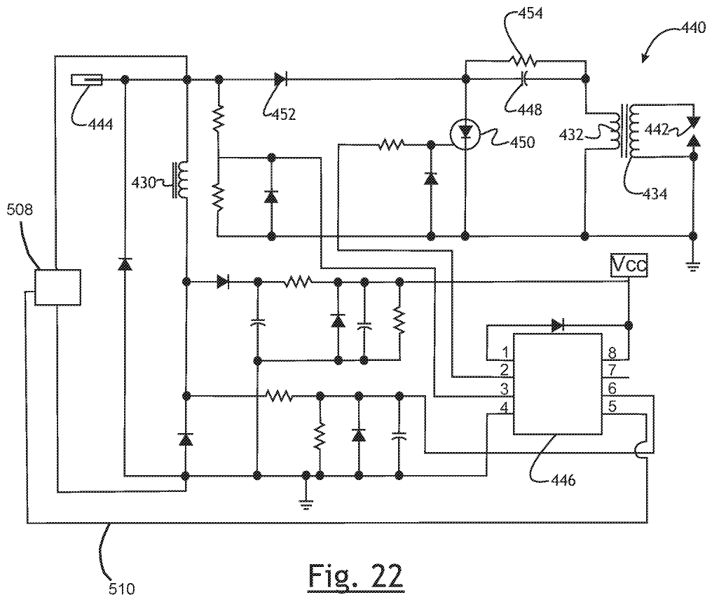

While the above systems and methods have been described with general reference to a TCI system, similar engine phase detection systems and methods can be utilized with a CDI system such as that shown in FIG. 22 or other magneto ignition system. Circuit 440 interacts with charge coil 430, primary ignition coil 432, and a kill switch 444, and generally comprises a microcontroller 446, an ignition discharge capacitor 448, and an ignition switch 450. The majority of the energy induced in charge coil 430 is provided to the ignition discharge capacitor 448, which stores the induced energy until the microcontroller 446 permits it to discharge. According to an embodiment shown here, a positive terminal of charge coil 430 is coupled to a diode 452, which in turn is coupled to ignition discharge capacitor 448. A resistor 454 may be coupled in parallel to the charge ignition discharge capacitor 448. The microcontroller 446 as shown in FIG. 22 can store code for the ignition timing systems described herein. Various microcontrollers or microprocessors may be used, as is known to those skilled in the art.

During operation of the engine, rotation of the flywheel 12 causes the magnetic elements, such as pole shoes 16, 18, to induce voltages in the various coils arranged around the lamination stack 24. One of those coils is the charge coil 430, which charges ignition discharge capacitor 448 through diode 452. A trigger signal from the microcontroller 446 activates switch 450 so that the ignition discharge capacitor 448 can discharge and thereby create a corresponding ignition pulse in ignition coil. In one example, the ignition switch 450 can be a thyristor, such as a silicon controlled rectifier (SCR). When the ignition switch 450 is turned ‘on’ (in this case, becomes conductive), the switch 450 provides a discharge path for the energy stored on ignition discharge capacitor 448. This rapid discharge of the ignition discharge capacitor 448 causes a surge in current through the primary ignition coil 432 of the ignition coil, which in turn creates a fast-rising electro-magnetic field in the ignition coil. The fast-rising electro-magnetic field induces a high voltage ignition pulse in secondary ignition coil 434. The ignition pulse travels to spark plug 442 which, assuming it has the requisite voltage, provides a combustion-initiating spark. Other sparking techniques, including flyback techniques, may be used instead, and as noted above, other ignition systems, including TCI and IDI systems, may be used.

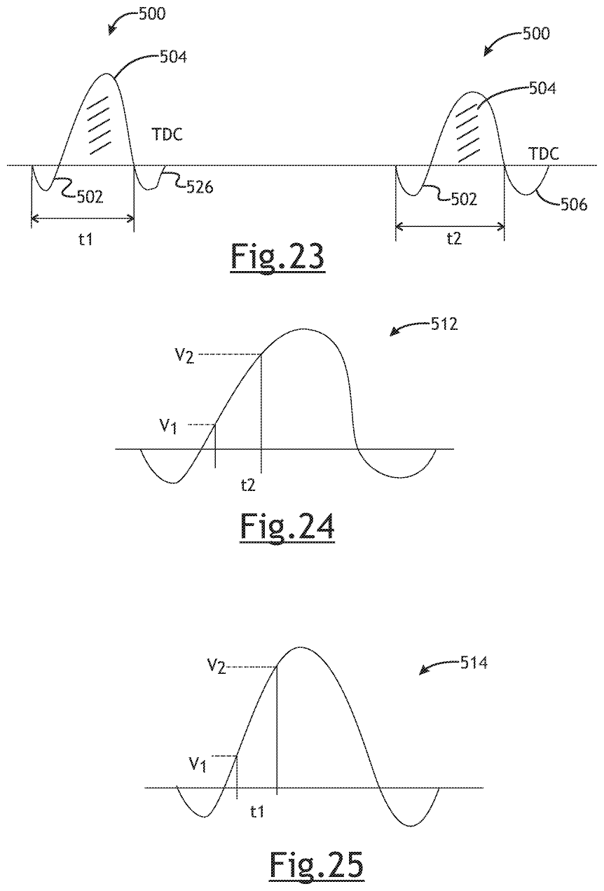

As shown in FIG. 23, when the magnet(s) on the flywheel pass the charge coil 430 in a CDI system such as is shown in FIG. 22, a voltage waveform 500 induced in the charge coil 430 may be sinusoidal and initially negative (shown at 502), then positive (shown at 504), and then negative again (shown at 506) as the magnet moves away from the charge coil. The voltage induced in the charge coil 430 may be determined by a voltage converter 508 connected in parallel with the charge coil, as shown in FIG. 22, and having an output 510 communicated with the microprocessor 446. Two waveforms 500 are shown in FIG. 23, with the waveform on the left occurring during an exhaust phase of the engine operation and the plot on the right occurring during a compression phase of engine operation. The engine speed is faster during the exhaust phase of engine operation than during the compression phase. Thus, a time (t1) from the beginning of the pulse in the charge coil 430 until the positive portion 504 of the pulse ends is shorter during the exhaust phase than is a time (t2) for the same portion of the waveform during the compression phase. Thus, in this example, (t1) is less than (t2). Thus, all or a portion of the voltage waveforms 500 can be used to determine engine speed during different phases of engine operation, and differences in engine speed can be used to differentiate between the phases of engine operation. While the example may use the time between incidents of the voltage in the coil being at zero volts (e.g. crossing between positive and negative voltage), other voltage thresholds may be used for measuring the lapsed times, as desired. With this information, the methods described above can be employed with a CDI system. And while described above with regard to the charge coil 430, the voltage waveforms of another coil may be used instead in the same manner. Such a method may be used in a CDI system wherein the ignition duration may be much shorter than in a TCI system as described above. The shorter ignition duration in a CDI system may make this method and that described below easier to implement in a CDI system. In at least some implementations, the magnet(s) on the flywheel may be oriented so that the final portion of the induced energy is at or within 10 degrees of a top dead center position of a piston of the engine, although other orientations may be used. This is indicated generally by the notation TDC at the end of the waveforms in FIG. 23.

Similarly, FIG. 24 illustrates a voltage waveform 512 in a coil (e.g. the charge coil 430) during an engine compression phase. And FIG. 25 illustrates a voltage waveform 514 in the same coil during an engine exhaust phase. The time needed for the voltage in the coil to increase from v1 to v2, which voltage values may be chosen as desired for a particular application, may be compared between the two waveforms 512, 514. Because engine speed is higher during the exhaust phase, the time (t1, shown in FIG. 25) for the voltage to increase from v1 to v2 in the exhaust phase waveform is less than the time (t2, shown in FIG. 24) needed for the same voltage increase in the compression phase waveform. In other words, the slope of the waveform between v1 and v2 is greater in the exhaust phase waveform 514 than in the compression phase waveform 512. The time/slope differences can be used to determine the various engine phases and with this information, the methods described above can be employed with a CDI system.

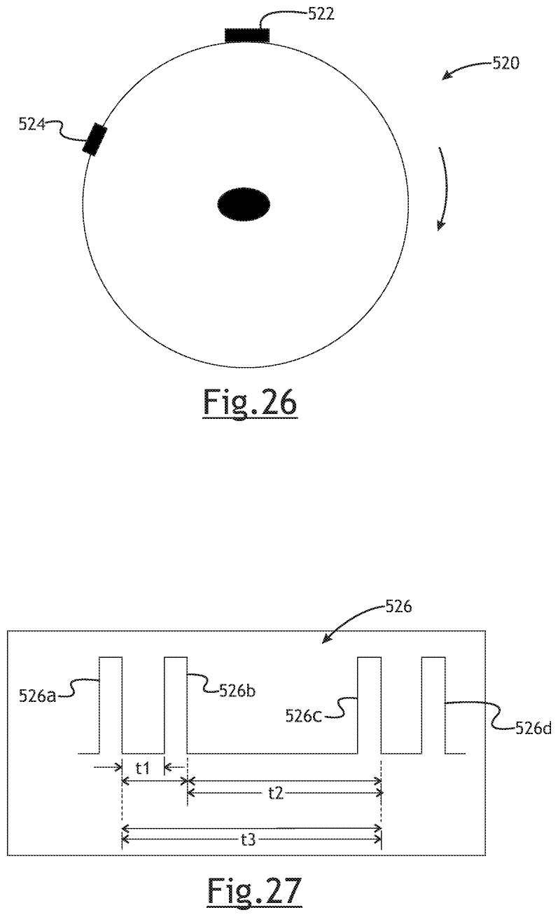

FIG. 26 illustrates a flywheel 520 having two magnets 522, 524 thereon, spaced apart a known distance or angle from each other. FIG. 27 illustrates waveforms 526 (individually labeled 526a, 526b, 526c and 526d) caused by rotation of the magnets 522, 524 passed a sensor or coil. In the example shown, the magnets 522, 524 are spaced apart by an angle of about 70 degrees, although other angles may be used. So spaced, two waveforms 526 are generated each rotation of the flywheel 520, as shown in FIG. 27 which illustrates flywheel rotation of about 430 degrees (two passing of the magnets 522, 524 in this example). The waveforms 526 may be rectified to include only the positive portion of the pulses, as shown in FIG. 27, if desired.

The waveforms 526 can be used to compare the engine speed of consecutive engine revolutions to determine a slower one and a faster one of the consecutive revolutions. The slower revolution includes the compression phase of engine operation and the faster revolution includes the exhaust phase of engine operation. In particular, a relationship has been found between: 1) a time t1 from the end of the waveform 526a from the first magnet 522 to the end of the waveform 526b for the second magnet 524 (which is a function of the angular spacing of the magnets); 2) a time t2 from the end of the waveform 526b of the second magnet 524 from one revolution to the end of the waveform 526c of the first magnet 522 in the next revolution; and 3) a time t3 which includes both t1 and t2 (e.g. the total time of one revolution starting from and ending at the end of the waveforms 526a and 526c of the first magnet 522). The ratio of t1:t2 and/or the ratio of t1:t3 is different in an engine revolution including a compression phase than in an engine revolution including an exhaust phase. Because the compression phase causes a slower engine speed, the ratio of t1:t2 or t1:t3 in an engine revolution that includes a compression phase is greater than in an engine revolution that includes an exhaust phase. Thus, the ratio(s) can be compared for consecutive engine revolutions to enable an engine phase determination. While the end of the waveforms generated by the magnets 522, 524 were used in the example described above, the beginning of the waveforms could instead be used or some combination of beginning, end or other points in the waveform, as desired.

To reduce instances of incorrect phase determination, a threshold speed difference (or difference in the ratio t1:t2 and/or t1:t3) may be required before a phase determination is made. That is, a phase determination is made only if the speed/ratio difference between consecutive revolutions is at least as great as the threshold, which may be a first threshold. Further thresholds may be used, such as requiring a threshold number of consecutive determinations that agree with a particular phase determination before using the phase determination in a further method or process such as are set forth above. For example, if a phase determination is made in one set of two consecutive revolutions, then that determination can be compared to one or more subsequent determinations for subsequent revolutions (up to a second threshold number of engine revolutions) to ensure that the phases have been properly determined, where incorrect determinations are possible due to inconsistent (e.g. an intended acceleration or deceleration) or unsteady engine operation (unintended engine speed variance). In at least some implementations, complete agreement from all subsequent determinations within the second threshold number of revolutions need not be required. That is, in at least some implementations a third threshold number of determinations could be required to be in agreement within the second threshold number of engine revolutions. For example, if the second threshold is sufficient for 10 engine phase determinations, then the third threshold may require that 6 to 10 of the engine phase determinations be in agreement before a phase determination is accepted. Of course, other values and thresholds may be used.

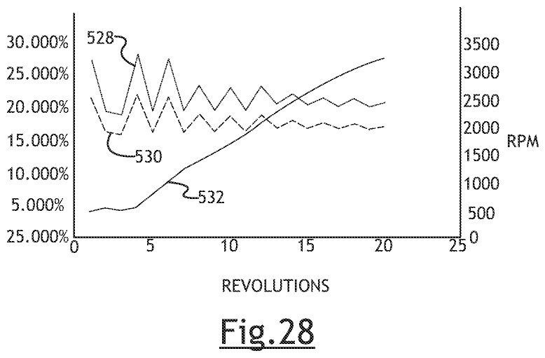

In FIG. 28, the ratio t1:t2 for consecutive revolutions is shown at line 528, the ratio t1:t3 at line 530, and engine speed in RPM is shown by line 532. The y-axis is for lines 528 and 530 is percentages of the ratios, and for line 532 is RPM. The x-axis is number of engine revolutions, and the plots are shown from engine revolution 1 at a speed of less than 500 rpm to engine revolution 20 at a speed of about 3,300 rpm. As engine speed increases, the differences in consecutive revolutions between the ratios t1:t2 and t1:t3 begin to become smaller. So, in at least some implementations, the engine phase determination may be made within a fourth threshold of engine revolutions, which may be between the first 5 to 20 revolutions, or between the first 5 and 10 engine revolutions after the engine has been started so that the determination is made when the differences in the ratios are larger. The second and fourth thresholds may be the same, and only one may be needed. In other implementations, the engine phase determination can be made at higher engine speeds and/or after a greater number of engine revolutions after the engine has been started. If desired in such implementations, a higher number of engine revolutions may be checked and may be required before an engine determination is accepted (e.g. the second and/or third thresholds may be higher).

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

1. A method of controlling spark events in a combustion engine, comprising:
determining for at least two engine revolutions in a four-stroke engine at least one characteristic of the primary coil voltage for a spark event;
determining, based upon the characteristic of the primary coil voltage, which of the spark events is associated with a compression phase of engine operation and which of the spark events is associated with an exhaust phase of engine operation; and
providing spark events in subsequent engine revolutions that are associated with the compression phase of engine operation but not in revolutions associated with the exhaust phase of engine operation.

2. The method of claim 1 wherein the characteristic is the duration of the spark event as determined by changes in the primary coil voltage.

3. The method of claim 1 wherein the characteristic is the duration that the primary coil voltage is above a threshold voltage.

4. (canceled)

5. A method of providing fuel to a multi-cylinder engine from a single control valve, comprising:
determining the intake phase of engine operation for each cylinder;
determining one or more of engine operating conditions including temperature, engine speed and number of revolutions since engine starting;
determining a fuel control valve instruction as a function of at least one of the engine operating conditions; and
opening a fuel control valve in accordance with the fuel control valve instruction and at a time corresponding with the intake phase of at least one cylinder.

6. The method of claim 5 wherein the fuel control valve instruction is determined as a function of engine temperature and number of revolutions since engine starting.

7. The method of claim 5 wherein the fuel control valve instruction is determined as a function of engine temperature and engine speed.

8. The method of claim 5 wherein the fuel control valve instruction includes one or more instructions as to the frequency that the fuel control valve is to be opened and the duration that the fuel control valve is opened during an actuation.

9. The method of claim 5 wherein the fuel control valve is opened one or both of less frequently and for a shorter duration of time when the engine is warmer than when the engine is colder.

10. The method of claim 5 wherein the fuel control valve instruction results in the fuel control valve being opened during the intake phase of each cylinder.

11. The method of claim 5 wherein the fuel control valve instruction results in the fuel control valve being opened during the intake phase of one cylinder but not the other.

12. The method of claim 5 wherein the fuel control valve instruction results in the fuel control valve being opened one or both of more frequently and for a longer duration during the intake phase of one cylinder compared to the fuel control valve actuation during the intake phase of the other cylinder.

13. A method of determining at least certain phases of engine operation for an engine with which a magneto ignition system is used, wherein the magneto ignition system includes a magnet and a coil in which energy is induced by the magnet, the method including:
comparing, during consecutive engine revolutions, at least one characteristic of the voltage induced in the coil; and
determining which revolution includes an exhaust phase of engine operation and which revolution includes a compression phase of engine operation based upon a difference in the at least one characteristic.

14. The method of claim 13 wherein the characteristic is the time for at least a portion of a waveform of the voltage induced in the coil.

15. The method of claim 14 wherein the waveform includes a first portion of a first polarity, a second portion of a second polarity and a third portion of the first polarity and the portion of the waveform from which the time is taken includes all of the second portion.

16. The method of claim 14 wherein the waveform includes a first portion of a first polarity, a second portion of a second polarity and a third portion of the first polarity and the portion of the waveform from which the time is taken includes the first portion and the second portion.

17. The method of claim 13 wherein the characteristic is one of the time or rate of change from a first voltage to a second voltage.

18. The method of claim 13 wherein the magneto includes two magnets located on a rotatable flywheel so that two waveforms are induced in the coil each revolution of the flywheel, and wherein the characteristic is the time for at least a portion of a revolution compared to the time for the entire revolutions, and such comparison is made for consecutive revolutions.

19. The method of claim 18 wherein the magnets are spaced apart a known distance and the time from the end of the waveform from a first magnet until the end of the waveform from a second magnet is compared to the time for a complete engine revolution.

20. The method of claim 18 wherein the magnets are spaced apart a known distance and the time from the end of the waveform from a first magnet until the end of the waveform from a second magnet is compared to the time from the end of the waveform from the second magnet to the end of the waveform from the first magnet in the next engine revolution.

21. The method of claim 19 wherein the comparisons or ratios of times are both used in determining engine phases of operation.
